(19) United States
(12) Patent Application Publication
(10) Pub. No.: US 2014/0047129 A1
(43) Pub. Date: Feb. 13, 2014

(54) METHOD, APPARATUS, AND COMPUTER PROGRAM PRODUCT FOR INTERFACING WITH AN UNIDENTIFIED HEALTH INFORMATION TECHNOLOGY SYSTEM

(71) Applicants: Arien Malec, Oakland, CA (US); Brian Adams, San Leandro, CA (US)

(72) Inventors: Arien Malec, Oakland, CA (US); Brian Adams, San Leandro, CA (US)

(73) Assignee: McKesson Financial Holdings, Hamilton (BM)

(21) Appl. No.: 13/571,112

(22) Filed: Aug. 9, 2012

(51) Int. Cl. G06F 15/16

(52) U.S. Cl. 709/246

(57) ABSTRACT

A method for analyzing data received from an identified third party health information technology system to identify the third party health information technology system is provided. The method may include, by a third party identification apparatus, receiving data from a health information technology system, analyzing the data, identifying the format of the data based on an analysis of the data, and extracting one or more data elements from the data in accordance with the format that was identified. Corresponding apparatuses and computer program products are also provided.

### TECHNOLOGICAL FIELD

Embodiments of the present invention relate generally to computer technology and, more particularly, relate to methods, apparatuses, and computer program products for interfacing with a third party health information technology (HIT) system.

### BACKGROUND

The widespread use of modern computing technology has led to an increasing demand for information to be captured and shared amongst computer-based applications. The medical services industry in particular relies on systems to store and maintain patient data in a centralized location made accessible to various authorized users. Third party HIT systems may access shared electronic health records (EHRs) and other consolidated information, maintained on a centralized system in order to provide the most up to date patient data available to health care providers and other customers.

There are a variety of third party HIT systems with at least some of the third party HIT systems providing data, such as EHR data, that is formatted in different manners. As such, it may be somewhat complex to communicate with each of a plurality of third party HIT systems since different interfaces may be required to communicate with the different HIT systems. Thus, substantial resources may be required to be dedicated to the design and implementation of the various interfaces that are required to communicate with third party HIT systems.

### BRIEF SUMMARY OF SOME EXAMPLE EMBODIMENTS

Methods, apparatuses, and computer program products are therefore provided for interfacing with a third party HIT system, such as between a third party HIT system and a centralized HIT system. Embodiments described herein may reduce the need for manual configuration or selection of interface specifications. Similarly, the necessity for systems administrators of a third party HIT system to be experienced or knowledgeable with regard to a specific HIT system may be reduced.

A method is provided, including receiving data from an HIT system. A format of the data may not be pre-established with respect to a recipient of the data. The method further includes analyzing the data, identifying the format of the data based on an analysis of the data, and extracting one or more data elements from the data in accordance with the format that was identified.

In some embodiments, analyzing the request comprises identifying a unique characteristic of the data that is associated with a respective HIT system, and identifying the format comprises identifying the format based on the respective HIT system. In some embodiments, analyzing the request comprises generating an interface and testing compatibility of the data with the interface. The method may include repeating the generating and testing until a compatible interface is generated.

In some embodiments, an apparatus is provided comprising processing circuitry configured to cause the apparatus to receive data from a health information system. A format of the data may not be pre-established with respect to the apparatus. The processing circuitry may further cause the apparatus to analyze the data, identify the format of the data based on an analysis of the data, and extract one or more data elements from the data in accordance with the format that was identified. In some embodiments, the processing circuitry may be configured to analyze the request by identifying a unique characteristic of the data that is associated with a respective HIT system, and may be configured to identify the format by identifying the format based on the respective HIT system. According to some embodiments, the processing circuitry may be configured to analyze the request by generating an interface, and testing compatibility of the data with the interface. The processing circuitry may be further configured to cause the apparatus to repeat the generating and testing until a compatible interface is generated.

In some embodiments, a computer program product comprising at least one non-transitory computer-readable medium having computer-readable program instructions stored therein with the computer-readable program instructions comprising instructions, which when performed by an apparatus, are configured to cause the apparatus to receive data from a HIT system. A format of the data may not be pre-established with respect to the computer program product. The instructions may be further configured to cause the apparatus to analyze the data, identify the format of the data based on an analysis of the data, and extract one or more data elements from the data in accordance with the format that was identified. In some embodiments, the instructions configured to analyze the request comprise instructions configured to identify a unique characteristic of the data that is associated with a respective health information system, and the instructions configured to identify the format comprise instructions configured to identify the format based on the respective health information system. According to some embodiments, the instructions configured to analyze the request comprise instructions configured to generate an interface and test compatibility of the data with the interface. The instructions may be further configured to cause the apparatus repeat the generating and testing until a compatible interface is generated.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a HIT system connected to a third party HIT system over a network according to some example embodiments;

FIG. 2 illustrates a block diagram of a third party identification apparatus in accordance with some example embodiments; and

FIGS. 3A and 3B illustrate flowcharts for interfacing with a third party HIT system according to some example embodiments.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, where a computing device is described herein to receive data from another computing device, it will be appreciated that the data may be received directly from the another computing device and/or may be received indirectly via one or more intermediary computing devices, such as, for example, one or more servers, relays, routers, network access points, and/or the like. Similarly, where a computing device is described herein to send data to another computing device, it will be appreciated that the data may be sent directly to the another computing device or may be sent to the another computing device via one or more interlinking computing devices, such as, for example, one or more servers, relays, routers, network access points, and/or the like.

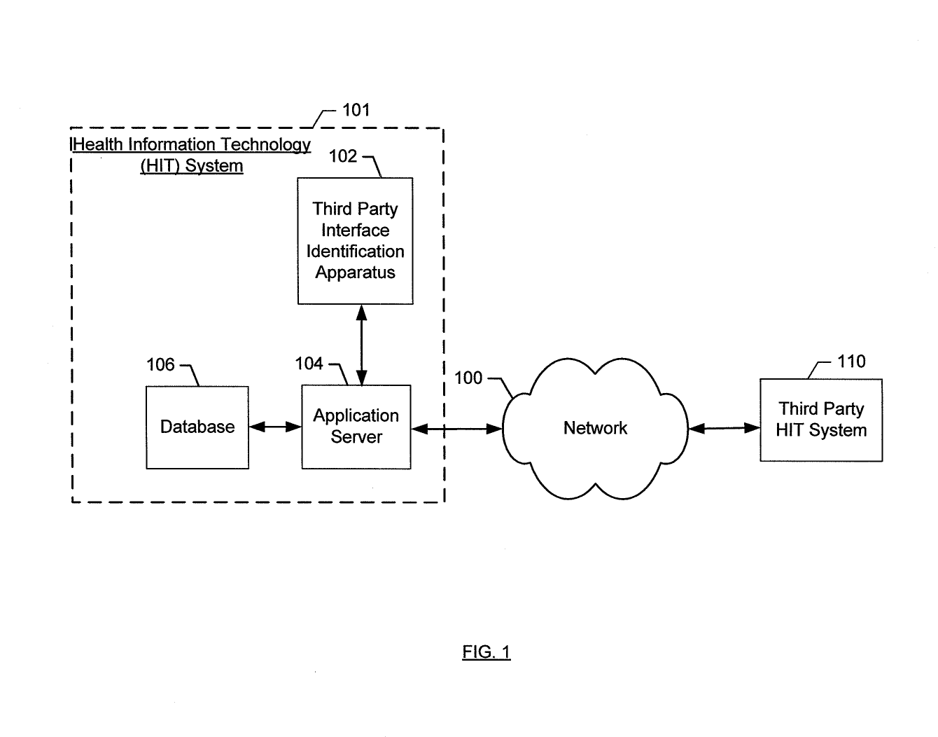

FIG. 1 illustrates a system 101 accessible from a third party HIT system 110 over network 100. It will be appreciated that the system of FIG. 1 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, numerous other configurations may also be used to implement embodiments of the present invention.

The system 101 may include any number of application server(s) 104 that may support and/or provide application code written in a variety of languages, providing various applications to enter, maintain, or otherwise access EHRs and/or other data stored in database 106. In some embodiments, database 106 may be implemented as any number of databases and may be accessible to application server(s) 104 via direct connection and/or over a network. In some embodiments, database 106 may be implemented on the same apparatus as an application server 104.

In some embodiments, system 101 may include a third party interface identification apparatus 102 that may be configured to identify third party systems communicating with application servers 104. Third party identification interface apparatus 102 may be directly coupled to the application server(s) 104, or accessed over a network. For example, in embodiments in which a third party interface identification apparatus 102 is disposed remotely from the application server(s) 104, EHR data may be provided to the application server(s) 104 via a network 100, by a variety of connections. Network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, wireless wide area network, some combination thereof, or the like), or a combination thereof, and in some example embodiments comprises at least a portion of the Internet.

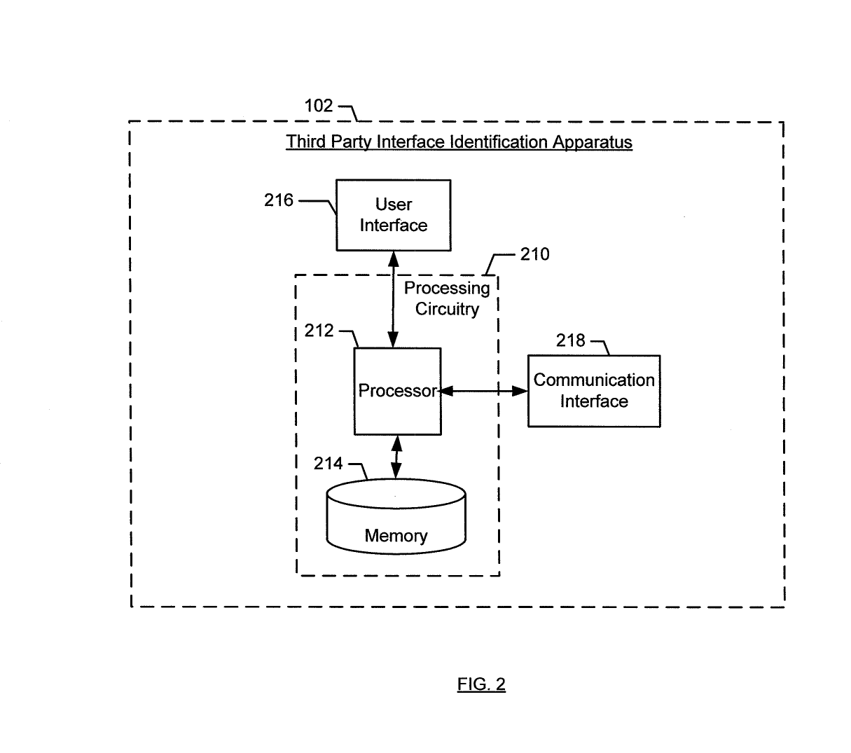

In some example embodiments, third party interface identification apparatus 102 may be embodied as or comprise one or more computing devices, such as, by way of non-limiting example, a server, configured to access network 100 and/or application server(s) 104. In some example embodiments, third party interface identification apparatus 102 may be implemented as a distributed system or a cloud based entity that may be implemented within network 100. In this regard, third party interface identification apparatus 102 may comprise one or more servers, a server cluster, one or more network nodes, a cloud computing infrastructure, some combination thereof, or the like. Additionally or alternatively, third party interface identification apparatus 102 may be implemented as a web service. In some embodiments, third party interface identification apparatus 102 may be implemented in the same apparatus as one or more application server(s) 104. An example embodiment of third party interface identification apparatus 102 is illustrated in FIG. 2 and is described in further detail hereinafter.

Any number of third party HIT systems 110, hereinafter referred to as system(s) 110, may be configured to communicate with HIT system 101 over network 100. System(s) 110 may be maintained by an entity such as a health care, prescriptions, and/or insurance provider, and may be configured to access and/or provide information stored on database 106 via an interface provided by application server(s) 104. System(s) 110 may be implemented in a variety of configurations, and may include application servers configured to communicate with an interface of application server(s) 104.

FIG. 2 illustrates a third party interface identification apparatus 102 in further detail, in accordance with some example embodiments. However, it should be noted that the components, devices, and elements illustrated in and described with respect to FIG. 2 below may not be mandatory and thus some may be omitted in certain embodiments. Additionally, some embodiments may include further or different components, devices, or elements beyond those illustrated in and described with respect to FIG. 2.

The third party identification apparatus 102 of one embodiment includes processing circuitry 210. Processing circuitry 210 may be configured to perform actions in accordance with one or more example embodiments disclosed herein. In this regard, the processing circuitry 210 may be configured to perform and/or control performance of one or more functionalities of the third party interface identification apparatus 102 in accordance with various example embodiments. The processing circuitry 210 may be configured to perform data processing, application execution, and/or other processing and management services according to one or more example embodiments. In some embodiments, the third party interface identification apparatus 102 or a portion(s) or component(s) thereof, such as the processing circuitry 210, may be embodied as or comprise a circuit chip. The circuit chip may constitute means for performing one or more operations for providing the functionalities described herein.

In some example embodiments, the processing circuitry 210 may include a processor 212 and, in some embodiments, such as that illustrated in FIG. 2, may further include memory 214. The processing circuitry 210 may be in communication with or otherwise control a user interface 216, and/or a communication interface 218. As such, the processing circuitry 210 may be embodied as a circuit chip (e.g., an integrated circuit chip) configured (e.g., with hardware, software, or a combination of hardware and software) to perform operations described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of third party interface identification apparatus 102 as described herein. The plurality of processors may be embodied on a single computing device or distributed across a plurality of computing devices collectively configured to function as the third party interface identification apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA, or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the third party interface identification apparatus 102. The memory 214 may be configured to store information, data, applications, instructions and/or the like for enabling the third party interface identification apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. In some cases, the memory 214 may be in communication with one or more of the processor 212, user interface 216, or communication interface 218, for passing information among components of third party interface identification apparatus 102.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. In some example embodiments in which the third party interface identification apparatus 102 is embodied as a server, cloud computing system, or the like, aspects of user interface 216 may be limited or the user interface 216 may not be present. Accordingly, the user interface 216 may provide input and output means to facilitate third party identification operations in accordance with one or more example embodiments.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable third party interface identification apparatus 102 to communicate with application server(s) 104 and/or database 106. Accordingly, the communication interface 218 may, for example, include supporting hardware and/or software for enabling communications via cable, digital subscriber line (DSL), universal serial bus (USB), Ethernet, or other methods.

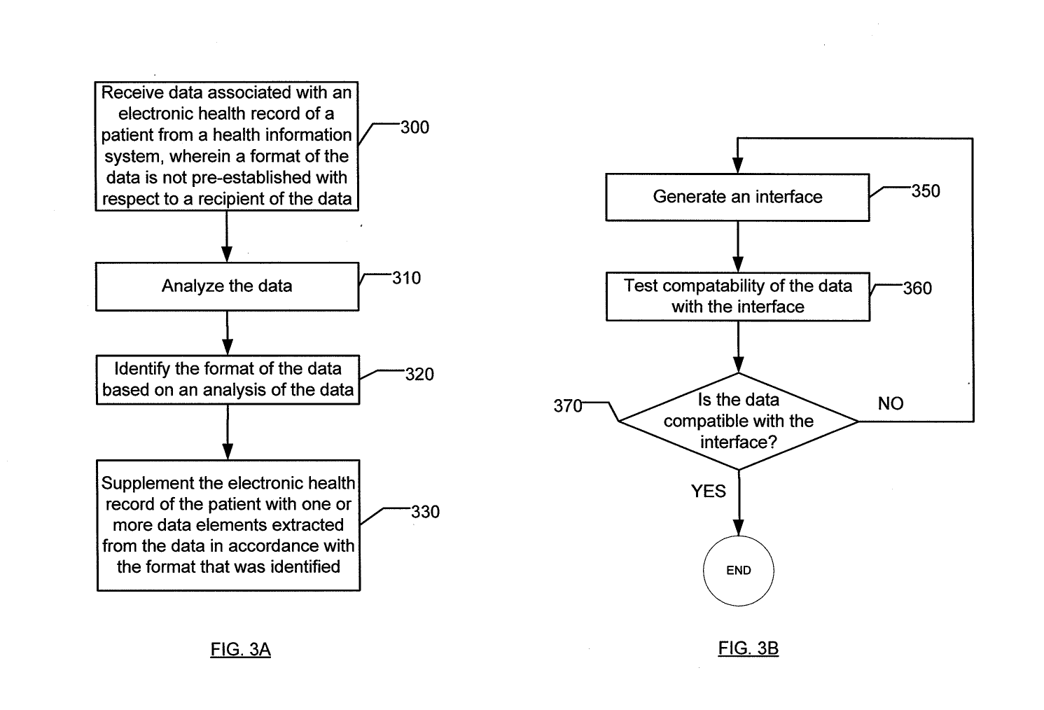

FIGS. 3 and 4 are flowcharts of operations according to some embodiments. Operations illustrated in FIG. 3 may be performed by a third party interface identification apparatus 102 and, more particularly, may be performed by, with the assistance of, and/or under the control of one or more of the processing circuitry 210, processor 212, memory 214, user interface 216, and/or communication interface 218.

In FIG. 3A, at operation 300, third party interface identification apparatus 102 may receive, such as by communication interface 218, data from a third party HIT system. For example, the data may be associated with an EHR of a patient to be updated on HIT system 101 in response to a request by the third party HIT system 110. It will be appreciated that an update to an EHR is used merely as an example, and the operations described herein may be performed in conjunction with any other type of data relating to HIT systems, such as, but not limited to, practice management data, billing data, and/or prescription data.

In some embodiments, a format of the data received at operation 300 may not be pre-established with respect to the third party interface identification apparatus 102 that serves as the recipient of the data. In other words, the third party interface identification apparatus 102 does not know in advance the format of the data received from the HIT system since the third party interface identification apparatus may not know the identity of the HIT system or, even if the identity of the HIT system is known, may not have previously communicated with the HIT system. In this regard, the data may not be in a readable or otherwise interpretable format for third party interface identification apparatus 102, or processor 212, because the format has not been pre-established with HIT system 101. HIT system 101 may require the data to be in a readable or otherwise interpretable format in order to interpret the data and update database 106 with correct information.

At operation 310, third party interface identification apparatus 102 may analyze the data, such as by processing circuitry 210 or processor 212. An analysis may include parsing data elements from an unstructured to structured format, cleaning the data to remove unwanted characters or noise, and/or transforming data elements into a format that may be interpreted by processor 212. Continuing to operation 320, processing circuitry 210, such as processor 212, may identify the format of the data based on an analysis of the data. The format of the data may define the manner in which the plurality of data elements that are included within the data should be interpreted, e.g., patient identifier, birth date, street address, etc., the sequence in which the data elements are presented, the number of characters that comprise each data element and/or the format of each data element. For example, processor 212 may identify a format of a data element “mm/dd/yyyy” as being in a date format, or a format of “123 xyz St.” as being a street address format. In some embodiments, processor 212 may process all the data received and identify a format the data in its entirety, such as in a scenario where all required data is received together. In some embodiments, processor 212 may analyze the data on a field by field basis.

At operation 330, processing circuitry 210, such as processor 212, may supplement the EHR of the patient with one or more data elements extracted from the data in accordance with the format that was identified. For example, processor 212 may identify an EHR based on a patient name or other identifier extracted from the data. The respective EHR may then be updated with additional data elements extracted from the data and communicated to the database 106, such as via communication interface 218.

FIG. 3B illustrates operations that may be performed by third party interface identification apparatus 102 to analyze the data and to identify the format of the data in accordance with some example embodiments. At operation 350, processing circuitry 210, such as processor 212, may generate an interface, or otherwise access an interface stored on memory 214. The interface may be a Health Level 7 (HL7) interface, or any other interface designed to enable communication between or with HIT systems. At operation 360, processing circuitry 210, such as processor 212, may test the compatibility of the data with the interface. The compatibility may be tested, for example, by processing the data received from a third party HIT system with the interface and then reviewing the results to determine if the interface properly interpreted and processed the data or, instead, if the interface was unable to properly interpret and process the data. By way of example with respect to testing the compatibility of the interface, the interface may perform an operation, such as an interfacing test method, on the data provided by the third party HIT system and catch any exceptions thrown by the operation.

At operation 370, the processing circuitry 210, such as processor 212, may determine if the interface is compatible with the data. For example, if the interface is determined to have not properly interpreted and processed the data provided by the third party HIT system, the processor may determine that the interface is not compatible with the data and return to operation 350. In one embodiment, if an exception is thrown, processor 212 may determine the interface is not compatible with the data and return to operation 350. However, if the interface is determined to have properly interpreted and processed the data provided by the third party HIT system, such as by not throwing an exception, the processor may determine that the interface is compatible.

In instances that the processor 212 determines the interface is compatible with the data, the processor 212 will have identified the format of the data (as a format with which the interface is compatible) and may return to performing operations described with respect to FIG. 3A. However, in scenarios that processor 212 determines the interface and data are not compatible, such as in the scenario the processor 212 catches an exception, the processor 212 may repeat operations 350-370, albeit with a different interface. For example, in subsequent iterations of operation 350, processor 212 may modify an interface based on the outcome of the compatibility test. In this regard, processor 212 may have identified a format for some data elements, but not all of the data elements, with the prior interface. As such, the processor 212 may modify the interface to differently interpret the data elements for which the format remains unknown, while continuing to process the data elements for which the format is now known in the same manner as performed by the prior interface. In some embodiments, the operations of FIG. 3A and/or FIG. 3B may be performed as a part of a tracer bullet approach to identifying a compatible interface. In this regard, processor 212 may utilize known data points to discover the format of the data.

Although one technique for determining the format of the data provided by a third party HIT system has been described above for purposes of example, the system, method and computer program product of example embodiments may analyze the data in various other manners in order to determine the format of the data. For example, the processing circuitry 210 may know in advance one or more unique characteristics with respect to the manner in which each of a plurality of third party HIT systems format data. As such, the processing circuitry 210 may analyze the data provided by a third party HIT system to determine if the data includes the unique characteristics of any one of the plurality of third party HIT systems. In an instance in which the processing circuitry 210 does determine that the data provided by a third party HIT system includes a unique characteristic associated with a respective one of the plurality of third party HIT systems, the processing circuitry may determine that the data was provided by the respective third party HIT system such that the data may thereafter be interpreted in accordance with the pre-established format utilized by the respective third party HIT system.

FIGS. 3A and 3B each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a third party interface identification apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a third party interface identification apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving data associated from a health information technology system, wherein a format of the data is not pre-established with respect to a recipient of the data;
analyzing the data with a processor;
identifying the format of the data based on an analysis of the data; and
extracting one or more data elements from the data in accordance with the format that was identified.

2. A method according to claim 1, wherein analyzing the request comprises identifying a unique characteristic of the data that is associated with a respective health information technology system, and wherein identifying the format comprises identifying the format based on the respective health information technology system.

3. A method according to claim 1, wherein analyzing the request comprises:
generating an interface; and
testing compatibility of the data with the interface.

4. A method according to claim 3, further comprising:
in an instance where the request and interface are not compatible, repeating the generating and testing until a compatible interface is generated.

5. A method according to claim 1, wherein analyzing the request comprises:
analyzing the data in its entirety.

6. A method according to claim 1, wherein analyzing the request comprises:
parsing the data into fields; and
analyzing the data field by field.

7. An apparatus comprising processing circuitry configured to cause the apparatus to at least:
receive data from a health information system, wherein a format of the data is not pre-established with respect to the apparatus;
analyze the data;
identify the format of the data based on an analysis of the data; and
extract one or more data elements from the data in accordance with the format that was identified.

8. An apparatus according to claim 7, wherein the processing circuitry is configured to analyze the request by identifying a unique characteristic of the data that is associated with a respective health information technology system, and wherein the processing circuitry is configured to identify the format by identifying the format based on the respective health information technology system.

9. An apparatus according to claim 7, wherein the processing circuitry is configured to analyze the request by:
generating an interface; and
testing compatibility of the data with the interface.

10. An apparatus according to claim 9, wherein the processing circuitry is further configured to cause the apparatus to:
in an instance where the request and interface are not compatible, repeat the generating and testing until a compatible interface is generated.

11. An apparatus according to claim 7, wherein the processing circuitry is configured to analyze the request by:
analyzing the data in its entirety.

12. An apparatus according to claim 7, wherein the processing circuitry is configured to analyze the request by:
parsing the data into fields; and
analyzing the data field by field.

13. A computer program product comprising at least one non-transitory computer-readable medium having computer-readable program instructions stored therein, the computer-readable program instructions comprising instructions, which when performed by an apparatus, are configured to cause the apparatus to at least:
receive from a health information technology system, wherein a format of the data is not pre-established with respect to a recipient of the data;
analyze the data;
identify the format of the data based on an analysis of the data; and
extract one or more data elements from the data in accordance with the format that was identified.

14. A computer program product according to claim 13, wherein the instructions configured to analyze the request comprise instructions configured to identify a unique characteristic of the data that is associated with a respective health information technology system, and wherein the instructions configured to identify the format comprise instructions configured to identify the format based on the respective health information technology system.

15. A computer program product according to claim 13, wherein the instructions configured to analyze the request comprise instructions configured to:
generate an interface; and
test compatibility of the data with the interface.

16. A computer program product according to claim 15, wherein the instructions are further configured to cause the apparatus to:
in an instance where the request and interface are not compatible, repeat the generating and testing until a compatible interface is generated.

17. A computer program product according to claim 13, wherein the instructions configured to analyze the request comprise instructions configured to:
analyze the data in its entirety.

18. A computer program product according to claim 13, wherein the instructions configured to analyze the request comprise instructions configured to:
parse the data into fields; and
analyze the data field by field.
